(19) United States
(12) Patent Application Publication
(10) Pub. No.: US 2002/0142783 A1
(43) Pub. Date: Oct. 3, 2002

(54) Reduced acquisition time for GPS cold and warm starts

(76) Inventors: Cesar Sanchez Yoldi, Gorliz (ES); Alberto Martinez Lebena, Santander (ES)

Correspondence Address: JENKENS & GILCHRIST, P.C., Suite 3200, 1445 Ross Avenue, Dallas, TX, 75202-2799, US

(21) Appl. No.: 09/945,451

(22) Filed: Aug. 29, 2001

Related U.S. Application Data
(60) Provisional application No. 60/279,340, filed on Mar. 28, 2001.

(51) Int. Cl. H04Q 7/20

(52) U.S. Cl. 455/456; 455/426

(57) ABSTRACT

A system and method for reducing acquisition times in a GPS receiver enables determination at start-up of the GPS receiver of the occurrence of ephemeris data at the GPS receiver being older than approximately two hours or a change in a mobile country code and mobile network code of a cellular device associated with the GPS receiver. Data is obtained for the GPS receiver from a reference server responsive to occurrence of one of these conditions and the position of the GPS receiver is determined at a reduced acquisition time using the obtained data.

### BACKGROUND OF THE INVENTION

The duration of a GPS positioning process is directly dependent upon how much information the GPS receiver has. The positioning process can be quite long during a cold start operation. In this situation, the GPS receiver does not have much information. This happens the first time that a user turns on a GPS receiver, or when a user has traveled a long distance (more than 1000 Km.) from the previous position of operation of the GPS receiver. In the worst case scenario it may take up to 60 seconds for a GPS receiver to obtain positioning information. In some situations, this amount of time to obtain positioning information may be critical to a user. Even in non-time critical situations, the amount of power required during a 60 second positioning operation severely increases the battery requirements for the GPS receiver.

Solutions implemented in some existing stand-alone GPS receivers require the prompting of a user for the date, time and approximate position of the receiver. The user accesses different menus during the initialization procedure to provide the GPS receiver with the information. For OEM GPS receivers designed to be integrated with devices such as a mobile telephone or PDA, the information is provided to the GPS receiver by means of specific commands in the serial interface.

One drawback of the stand-alone GPS receiver is that there is no intelligence in the GPS receiver, reminding the user to update the location information. As a result, the cold start can be as long as 60 seconds if the information is not updated. If the user switches off the GPS receiver and moves further than 1000 Km. and reactivates the GPS receiver, the cold start will take some extended period of time unless the user realizes that he has moved and re-enters the location information. For users who frequently travel, updating the location and time of the GPS receiver can be a time consuming process. The user may forget to update this information or not know the approximate location. Moreover, combined positioning and information applications are very useful when a user first arrives within a new area, for example, when they are looking for a hotel or restaurant. However, this is when a user has little location and time information. For situations wherein the updating procedure is performed via a menu, the user must scroll through the list of different countries and select the one where the user is located. This means that the terminal must store this list. If the terminal supports different languages the translated list must also be stored. This requires a great deal of memory for this information to be stored within the terminal.

Another solution comprises GPS systems using differential positioning (DGPS). The idea behind differential positioning is to correct biasing errors at one location with measured errors at a known position. A reference receiver computes corrections for each satellite signal. These corrections are passed to the GPS receiver, which applies them to resolve the position of the receiver. There are different methods to pass the corrections to the GPS receivers including radio beacons in the U.S., public and private agencies using electronic means for post processing, FM sub-carrier broadcasts, satellite links, and private radio beacons. However, no matter which technique is used for passing the corrections to the GPS receiver, the procedure is complex, power consuming, expensive and not all techniques are valid everywhere.

In a network assisted GPS system, a GPS receiver is integrated within a cellular device. Local time, position estimates and satellite ephemeris and clock information are provided by the cellular network. Terminals including both GPS and cellular receivers capture the GPS assistance data from the network and use it to compute a position from the received GPS signal. Network assisted GPS systems improve the position accuracy and shorten delays within computing the position. There are different implementations depending on the particular cellular system used. However, network assisted GPS systems comprise complex solutions requiring additional elements within existing cellular networks. Without the required new elements, not all networks will support this functionality. Furthermore, use of network assisted GPS within a cellular system requires some small changes within the signaling protocol of cellular terminals. Thus, to fully implement this type of system in the majority of systems would require some years due to the changes in network infrastructure.

A system overcoming the shortcomings of these an other methods for minimizing the determination of positioning information by a GPS receiver is desired.

### SUMMARY OF THE INVENTION

The present invention overcomes the foregoing and other problems with a system and method for reducing acquisition times in a GPS receiver. At start-up, the GPS receiver checks for the occurrence of at least one of ephemeris data at the GPS receiver being older than approximately two hours or a change in a mobile country code and mobile network code of the GPS receiver. Upon determination of one of these conditions, data for the GPS receiver may be obtained from a reference server. Additionally, an approximate location of the GPS receiver may be determined by comparing the present mobile country code and mobile network code with a table including a plurality of mobile country codes and mobile network code pairs. Each code pair has an associated longitude and latitude. The longitude and latitude associated with a matching mobile country code and mobile network code pair are used to determine the approximate position of the GPS receiver and a more exact position is determined using the approximate position and the data obtained from the reference server.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a system operating according to the method of the present invention;

FIG. 2 illustrates the type of information necessary for a GPS receiver to begin in various start conditions;

FIG. 3 illustrates the information necessary in order for a GPS receiver to start in a hot start condition,

FIG. 4 is a flow diagram illustrating the conversion of a warm start condition to a hot start condition;

FIG. 5 is a flow diagram illustrating the conversion of a cold start condition to a hot start condition;

FIG. 6 is a flow diagram illustrating a determination of a cold start trigger;

FIG. 7 illustrates a table for determining an approximate position of a mobile device; and

FIG. 8 is a flow diagram illustrating the process using MCC (+MNC) codes to determine an approximate position of a mobile device.

### DETAILED DESCRIPTION

GPS receivers are programmed with almanac data that coarsely describes the satellite positions and is applicable for only one year. This information alone is not sufficient for generating a position solution In order to decrease the acquisition time and find a position solution, a GPS receiver requires knowledge of the approximate location of the receiver and a reasonably accurate time value. If the GPS receiver does not have this information, it does not know which satellites are visible and their approximate ranges. The GPS receiver must then search the entire length of the Gold code for each satellite. This procedure is even more difficult due to the motion of the satellites relative to the receiver. The apparent Doppler frequency depends on how much of the motion is along the line of sight from the receiver to satellite and is the range of +/−4 kHz in most areas. The search for each satellite must be across all possible code phases and Doppler frequencies. This takes a large amount of time. If reasonably accurate Real Time Clock information and approximate location is provided to the GPS receiver, an acquisition time of a few seconds can be possible.

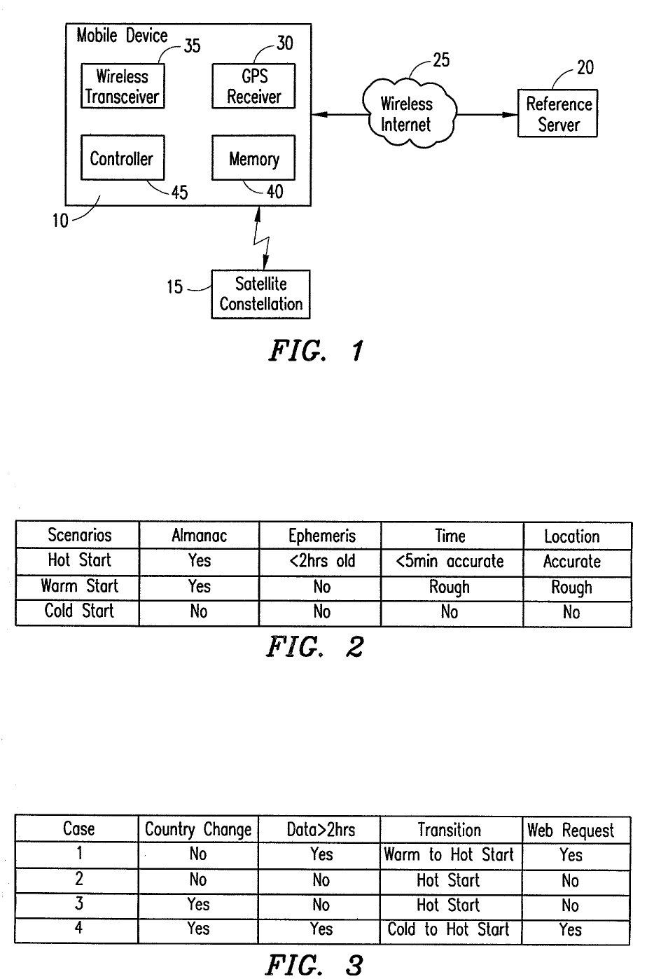

Referring now to FIG. 1, there is illustrated a system operating according to the method of the present invention. A mobile device 10 is in communication with both a satellite constellation 15 and a reference server 20 via the wireless Internet 25. By wireless Internet 25 we are referring to accessing the Internet via a wireless protocol such as the wireless access protocol (WAP) or any other mobile Internet protocol. While the following discussion will refer to WAP, it should be realized that any method of wirelessly accessing the Internet would be applicable. The mobile device 10 includes a GPS receiver 30 and a wireless telecommunications transceiver 35 implementing, for example, the GSM protocol. Again, it should of course be realized that other wireless systems as D-AMPS, etc., may be implemented by the wireless transceiver 35. A memory 40 is provided for storing information enabling the GPS receiver 30 to determine a position of the mobile device 10. Examples of data stored within the memory 40 include almanac data consisting of a set of parameters used by the GPS receiver 30 to predict the approximate locations of all GPS satellites and the expected satellite clock offsets and ephemeris data comprising a set of parameters used by the GPS receiver 30 to predict the location of a single GPS satellite and its clock behavior. Ephemeris data is more accurate than almanac data but is applicable only over a short time frame (4-6 hours). Position and time data of the mobile device 10 may also be stored in the memory 40.

The mobile station 10 is able to determine positioning information within four different type of situations referred to as “cold starts”, “warm starts”, “hot starts” and “snap starts”. Referring now to FIG. 2, there is illustrated the type of information necessary to have the GPS 30 receiver perform each of the different kinds of described start. A cold start occurs when the receiver has no almanac data and lacks ephemeris and time and/or location information. A cold start of a GPS receiver normally takes less than 60 seconds to occur. A warm start occurs when a GPS receiver has valid almanac and reasonably accurate time and location information, but lacks ephemeris data. This type of start normally takes less than 38 seconds. The hot start occurs when the receiver has valid ephemeris data and reasonably accurate position and time data and takes less than 8 seconds to perform. A snap start (not shown) occurs when the receiver has current ephemeris, accurate position and time data and normally takes less than 3 seconds to perform positioning.

In order to transform a cold start condition to a hot start condition, time, location, ephemeris and almanac data are all needed. The proposed solution provides the ephemeris and almanac data by accessing the wireless Internet using a wireless protocol such as WAP. Accurate location and prime information are obtained from the mobile device. Conversion of a warm start condition to a hot start condition only requires ephemeris data which is obtained via the wireless Internet using a wireless protocol such as WAP. Referring now to FIG. 3, there is illustrated a table for determining what information is required from the reference server 20 in four different cases responsive to an examination of two different triggers, namely, 1) an indication that ephemeris data is older than approximately two hours and, 2) a change in the country of location of the mobile station. These triggers indicate whether it is likely that new data will be needed to convert either a warm or cold start into a hot start.

Case 1 corresponds to the case where the user has not moved from their country but the ephemeris data is too old to accurately locate the user. This is a warm start condition. Case 2 describes the case where the user has switched off the mobile device for less than 2 hours and has not made any large movements. In this case no data acquisition is necessary. Case 3 describes a situation wherein the country may have changed but there has not been a large movement, and the ephemeris data is not older than 2 hours so the existing data will still be valid. Case 4 describes a situation wherein a user has moved between different countries for a long distance (i.e., further than 1000 Km.) and, the user data is greater than 2 hours old. This corresponds to a cold start condition.

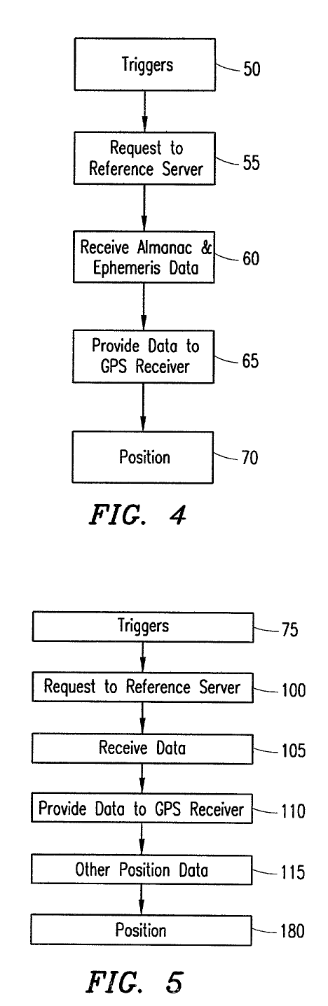

Referring now to FIG. 4, there is a flow diagram illustrating the process by which a warm start condition is converted into a hot start condition. If the triggers indicate that the hot start condition exists at step 50, a request is made at step 55 to the reference server 20 for the almanac and ephemeris data necessary to convert the warm start condition to the hot start condition. This connection is provided via the wireless Internet 25 between the mobile device 10 and reference server 20 as described previously with respect to FIG. 1 In one embodiment, a WAP GPRS transaction is used to request the information stored on the reference server 20. GPRS is herein utilized as an example, but the solution could also be applicable with any other wireless high-speed transmission bearer. The use of a GPRS transaction reduces time and causes the use of a WAP bearer, avoiding the setting up and releasing of a communications session. In order to assist the reference server in finding the required information, the request may include data a MCC (mobile country code) and UTC (universal time coordinated) format time. Using this information, the reference server 20 locates the correct almanac and ephemeris data for transmission back to and receipt by the mobile device 10 at step 60. The almanac and ephemeris data are provided from the wireless transceiver 35 to the GPS receiver 30 by means of NMEA (National Marine Electronic Association) commands. NMEA commands permit the interchange of information between the GPS receiver and other electronics equipment. NMEA is used only as an example, and any other means to communicate the GPS data to the cellular device may also be applicable. At step 70, the position of the mobile device 10 is determined from a hot start condition using the provided information.

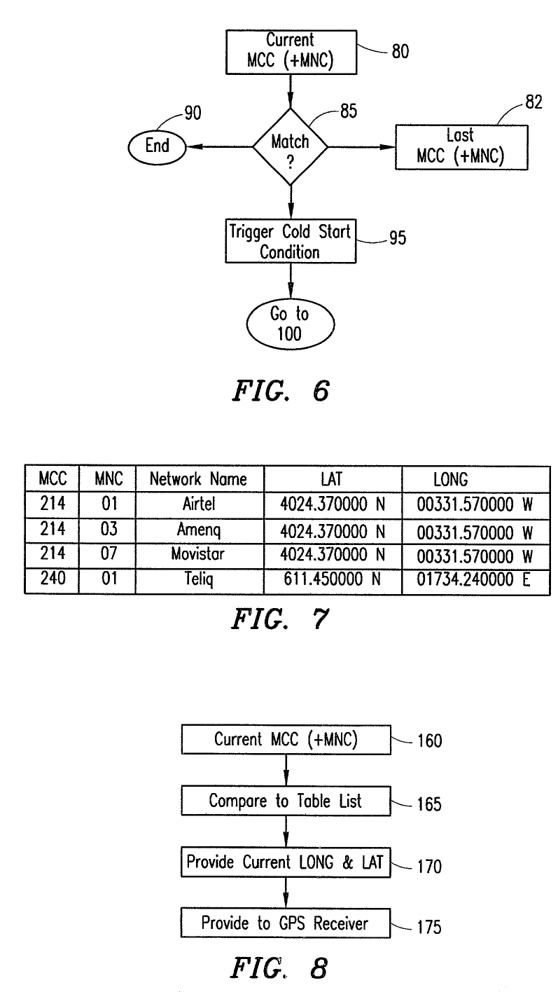

Referring now to FIG. 5, there is illustrated a flow diagram describing the process for converting a mobile device 10 from a cold start condition to a hot start condition. At step 75, a determination is made as to whether the triggers indicating a cold start condition are present. These comprise an indication that the ephemeris data is older than two hours and that the country in which the mobile station is located has changed. Determination of the age of the ephemeris data may be made by comparison of the time the last ephemeris data was received and the present time using information already located within the mobile device 10. The country change trigger may be determined as illustrated in FIG. 6. The current mobile country code and mobile network code 80 and the mobile country code and mobile network code 82 last used by the mobile device 10 are provided to inquiry step 85 to determine whether they match. If so, the process ends at step 90 and a cold start condition does not exist. If they do not match, a cold start condition is triggered at step 95, and control passes back to step 100 of FIG. 5. The mobile device 10 requests the ephemeris and almanac data from the reference server 20 using the wireless Internet 25 in a manner similar to that discussed with respect to FIG. 4. A WAP GPRS transaction is utilized to obtain the updated information from the reference server 20 and the request includes the MCC and UTC format time information in order to assist in location of the correct almanac and ephemeris data at the reference server 20. The located data is received back at the mobile device 10 at step 105 and the data is provided to the GPS receiver 30 using NMEA commands as described previously. Once almanac and ephemeris data have been obtained, accurate time and position information is obtained at step 115 to complete transition from the cold start condition to the hot start condition.

The mobile device 10 obtains the approximate position of the mobile device using the MCC (+MNC) code. This determination is made by accessing a table as illustrated in FIG. 7 which includes a list of MCC and MNC code pairs, their associated network, and longitude and latitude parameters associated with a selected position within the network. The latitude is a representative latitude point within the country of the network having the format ddmm.mmmmmml where d: stands for degrees; m: stands for minutes of degree; and l: stands for latitude (North or South). Similarly, the longitude parameter represents a longitude point within a country of the network having the format dddmm.mmmmmmL where d: stands for degrees; m: stands for minutes of degree; and L: stands for longitude (East or West). For each MCC MNC pair, a representative point is chosen depending on the geography and the population distribution. For example, in Spain, the capital is located substantially within the middle of the country so Madrid may be chosen as a representative point within the network serving Spain. In a country such as Sweden, where the population is more concentrated to the South, Stockholm, which lies to the South of the center of the country, might be chosen.

Referring now to FIG. 8, there is illustrated a process by which the mobile device 10 utilizes the MCC (+MNC) codes to determine an approximate position of the mobile device 10. This approximate position information enables the GPS receiver to shorten the acquisition time as described previously. The current MCC and MNC 160 is compared at 165 to the list of MCC and MNC codes to locate a matching MCC MNC pair. Once a matching pair is located, the longitude and latitude associated with the pair are provided at step 170. This information is provided to the GPS receiver at step 175 via an NMEA command.

Time information may be obtained from clock information stored in the mobile device 10. In a farther embodiment, the longitude of an old MCC (+MNC) code may be compared with the longitude of the current MCC (+MNC) code. When the difference between the longitude is greater than 15 degrees, it may be considered that the time zone does not change. Thus, there is no need to update the GPS with a new time. Once all information has been received by the GPS receiver, the device may then be started in a hot start condition and position the device at step 180 (FIG. 5).

The above-described invention allows the shortening of acquisition times during cold start and warm start processes by transforming them into a hot start process. Compared to existing solutions the described invention is simpler and easier to implement. Such methods will provide reduced power consumption by the mobile device by enabling the determining of positioning without scanning and obtaining information from each satellite within the GPS system.

The previous description is of a preferred embodiment for implementing the invention, and the scope of the invention should not necessarily be limited by this description. The scope of the present invention is instead defined by the following claims.

What is claimed is:

1. A method for reducing acquisition times in a GPS receiver associated with a cellular device, comprising the steps of:
determining at startup of the GPS receiver occurrence of at least one of the following conditions: ephemeris data at the GPS receiver older than a predetermined period of time and a change in a mobile country code and mobile network code of the cellular device associated with of the GPS receiver;
obtaining data for the GPS receiver from a reference server responsive to occurrence of one of the conditions; and
calculating a current position of the GPS receiver at a reduced acquisition time using at least the obtained data.

2. The method of claim 1, wherein the step of obtaining further comprises the step of obtaining ephemeris and almanac data from the reference server via the internet.

3. The method of claim 1, wherein the step of obtaining further comprises the step of obtaining ephemeris and almanac data using a WAP protocol.

4. The method of claim 1, wherein the step of determining further comprises the step of comparing a present mobile country code and mobile network code with a previous mobile country code and mobile network code to determine if a change has occurred in the mobile country code and mobile network code of the GPS receiver.

5. The method of claim 1, further comprising the step of obtaining an approximate position of the GPS receiver based upon a present mobile country code and mobile network code associated with the GPS receiver.

6. The method of claim 5, wherein the approximate position comprises a longitude and latitude.

7. The method of claim 5, wherein the step of obtaining the approximate position further comprises the steps of:
comparing the present mobile country code and mobile network code with entries in a table of mobile country codes and mobile network codes having position data associated therewith to locate a corresponding mobile country code and mobile network code; and
selecting the position data associated with a corresponding mobile country code and mobile network code as the approximate position of the GPS receiver.

8. The method of claim 1, wherein the step of calculating a current position further comprises the step of determining a current position using the approximate position of the GPS receiver.

9. The method of claim 1, further comprising the step of obtaining a present time associated with the GPS receiver based upon the mobile country code and the mobile network code associated with the GPS receiver.

10. The method of claim 9, wherein the step of obtaining the present time further comprises the steps of:
accessing a table of mobile country codes and mobile network codes having position data associated therewith;
comparing the present mobile country code and mobile network code with entries in the table to locate a corresponding mobile country code and mobile network code;
determining if the position data has changed by a selected amount between the present mobile country code and mobile network code and the corresponding mobile network code and mobile country code; and
if the position data has not changed by the selected amount, determining a time for a previously used time zone.

11. The method of claim 1, wherein the predetermined period of time corresponds to approximately two hours.

12. The method of claim 1, wherein the step of obtaining further comprises the step of obtaining ephemeris and almanac data using a Mobile Internet Protocol.

13. A method for reducing acquisition times in a GPS receiver associated with a cellular device, comprising the steps of:
determining at startup of the GPS receiver occurrence of a change in a mobile country code or mobile network code of the cellular device associated with the GPS receiver;
accessing a table of mobile country codes and mobile network codes having position data associated therewith;
comparing the present mobile country code and mobile network code with entries in the table to locate a corresponding mobile country code and mobile network code;
selecting the position data associated with a corresponding mobile country code and mobile network code as an approximate position of the GPS receiver; and
calculating a current position using the approximate position of the GPS receiver at a reduced acquisition time using at least the position data.

14. The method of claim 13, further comprising the step of obtaining ephemeris and almanac data from a reference server via the internet.

15. The method of claim 14, wherein the step of obtaining further comprises the step of obtaining ephemeris and almanac data using a Mobile Internet Protocol.

16. The method of claim 14, wherein the step of obtaining further comprises the step of obtaining ephemeris and almanac data using a WAP protocol.

17. The method of claim 13, wherein the step of determining further comprises the step of comparing a present mobile country code and mobile network code with a previous mobile country code and mobile network code to determine a change has occurred in a mobile country code or mobile network code of the GPS receiver.

18. The method of claim 13, further comprising the step of obtaining a present time associated with the GPS receiver based upon the mobile country code and the mobile network code associated with the GPS receiver.

19. The method of claim 18, wherein the step of obtaining a present time further comprises the steps of:
accessing a table of mobile country codes and mobile network codes having position data associated therewith;
comparing the present mobile country code and mobile network code with entries in the table to locate a corresponding mobile country code and mobile network code; and
determining if the position data has changed by a selected amount determining if the position data has changed by a selected amount between the present mobile country code and mobile network code and the corresponding mobile network code and mobile country code; and
if the position data has not changed by the selected amount, determining a time for a previously used time zone.

20. A wireless communications device, comprising:
a wireless transceiver for establishing a connection with the Internet;
a GPS receiver for determining a position of the wireless communications device;
a table including a plurality of mobile country code and mobile network code pairs, each pair of mobile country codes and mobile network codes having a longitude and latitude associated therewith;
a controller configured to:
determine at startup of the GPS receiver occurrence of at least one of the following conditions: ephemeris data at the GPS receiver older than a predetermined period of time and a change in a mobile country code and mobile network code of the wireless communications device;
obtain an approximate position of the GPS receiver from the table based upon a present mobile country code and mobile network code associated with the GPS receiver.
obtain data for the GPS receiver from a reference server on the Internet using the wireless transceiver responsive to occurrence of one of the conditions; and
determine a current position of the GPS receiver at a reduced acquisition time using at least the obtained data and the approximate position.

21. The wireless communications device of claim 20, wherein the predetermined period of time corresponds to approximately two hours.

22. The wireless communication device of claim 20, wherein the controller is further configured to obtain ephemeris and almanac data from the reference server via the internet.

23. The wireless communication device of claim 22, wherein the controller is further configured to obtain ephemeris and almanac data using a Mobile Internet Protocol.

24. The wireless communication device of claim 22, wherein the controller is further configured to obtain ephemeris and almanac data using a WAP protocol.

25. The wireless communication device of claim 20, wherein the controller is further configured to compare a present mobile country code and mobile network co de with a previous mobile country code and mobile network code to determine a change has occurred between mobile country code and mobile network code of the GPS receiver.

26. The wireless communication device of claim 20, wherein the approximate position comprises a longitude and latitude.

27. The wireless communication device of claim 20, wherein the controller is further configured to:
access the table of mobile country codes and mobile network codes having position data associated therewith;
compare the present mobile country code and mobile network code with entries in the table to locate a corresponding mobile country code and mobile network code; and
select the longitude and latitude associated with a corresponding mobile country code and mobile network code as the approximate position of the GPS receiver.

28. The wireless communication device of claim 20, wherein the controller is further configured to obtain a present time associated with the GPS receiver based upon the mobile country code and the mobile network code associated with the GPS receiver.

29. The wireless communication device of claim 28, wherein the controller is further configured to:
access a table of mobile country codes and mobile network codes having position data associated therewith;
compare the present mobile country code and mobile network code with entries in the table to locate a corresponding mobile country code and mobile network code; and
determine if the position data has changed by a selected amount;
if the position data has not changed by the selected amount, determine a time for a previously used time zone.
